(19) United States
(12) Patent Application Publication
(10) Pub. No.: US 2018/0067602 A1
(43) Pub. Date: Mar. 8, 2018

(54) TRANSPARENT PRESSURE SENSING FILM COMPOSITION

(71) Applicants: Rohm and Haas Electronic Materials LLC, Marlborough, MA (US); DOW GLOBAL TECHNOLOGIES LLC, Midland, MI (US)

(72) Inventors: Chao Zhang, Shanghai (CN); Peng Gao, Shanghai (CN); Minbiao Hu, Shanghai (CN); Daniel L. Dermody, Midland, MI (US); Tong Sun, Shanghai (CN); Zhuo Wang, Shanghai (CN); Peter Trefonas, III, Medway, MA (US); Michael E. Hus, Midland, MI (US); Yang Liu, Shanghai (CN)

(21) Appl. No.: 15/561,213

(22) PCT Filed: Mar. 30, 2015
(86) PCT No.: PCT/CN2015/075378

§ 371 Date: Sep. 25, 2017

(51) Int. Cl. G06F 3/041; G06F 3/045; H01B 1/22

(52) U.S. Cl. CPC G06F 3/0414; G06F 2203/04103; H01B 1/22; G06F 3/045

(57) ABSTRACT

A transparent pressure sensing film composition is provided having a matrix polymer; and, a plurality of conductive particles; wherein the matrix polymer comprises 25 to 100 wt % of an alkyl cellulose; and, wherein an electrical resistivity of the transparent pressure sensing film is variable in response to an applied pressure having a z-component directed along the thickness of the transparent pressure sensing film such that the electrical resistivity is reduced in response to the z-component of the applied pressure.

The present invention relates to a transparent pressure sensing film composition. The present invention is also directed to a method of making transparent pressure sensing films and devices comprising the same.

The market for electronic display devices, such as, televisions, computer monitors, cell phones and tablets is a competitive arena in which various product developers are in constant competition to provide improved product features at a competitive price.

Many electronic display devices both convey and receive information from the user through their display interface. Touch screens offer an intuitive means for receiving input from a user. Such touch screens are particularly useful for devices where alternative input means, e.g., mouse and keyboard, are not practical or desired.

Several touch sensing technologies have been developed including, resistive, surface acoustic wave, capacitive, infrared, optical imaging, dispersive signal and acoustic pulse. Each of these technologies operate to sense the position of a touch or touches (i.e., multi-touch) on a display screen. These technologies; however, do not respond to the magnitude of the pressure applied to the screen.

Touch sensitive devices responsive to the location and applied pressure of a touch are known. Such touch sensitive devices typically employ electrically active particles dispersed in a polymeric matrix material. The optical properties of these devices; however, are generally not compatible for use in electronic display device applications.

Accordingly, what is needed is a pressure sensing film that facilitates conventional touch and multi touch capabilities in combination with a pressure sensing capability and that is also optically transparent to facilitate use in optical display touch sensing devices.

Lussey et al. disclose a composite material adapted for touch screen devices. Specifically, in U.S. Patent Application Publication No. 20140109698, Lussey et al. disclose an electrically responsive composite material specifically adapted for touch screen, comprising a carrier layer having a length and a width and a thickness that is relatively small compared to said length and said width. The composite material also comprises a plurality of electrically conductive or semi-conductive particles. The particles are agglomerated to form a plurality of agglomerates dispersed within the carrier layer such that each said agglomerate comprises a plurality of the particles. The agglomerates are arranged to provide electrical conduction across the thickness of the carrier layer in response to applied pressure such that the electrically responsive composite material has a resistance that reduced in response to applied pressure. Lussey et al. further disclose that the electrically conductive or semi-conductive particles may be preformed into granules as described in WO 99/38173. Those preformed granules comprising electrically active particles coated with very thin layers of polymer binder.

Notwithstanding, there remains a continuing need for pressure sensing films that are optically transparent and facilitate production of touch sensitive displays that enable conventional touch and multi-touch inputs in addition to a pressure input.

The present invention provides a transparent pressure sensing film, comprising: a matrix polymer; and, a plurality of conductive particles; having an average aspect ratio, AR_{avg}, of ≦2; wherein the matrix polymer comprises 25 to 100 wt % of an alkyl cellulose; wherein the plurality of conductive particles are selected from the group consisting of electrically conductive materials and electrically semiconductive materials; wherein the plurality of conductive particles are disposed in the matrix polymer; wherein the transparent pressure sensing film contains <10 wt % of the plurality of conductive particles; wherein the transparent pressure sensing film has a length, a width, a thickness, T, and an average thickness, T_{avg}; wherein the average thickness, T_{avg}, is 0.2 to 1,000 μm; wherein the matrix polymer is electrically non-conductive; wherein an electrical resistivity of the transparent pressure sensing film is variable in response to an applied pressure having a z-component directed along the thickness, T, of the transparent pressure sensing film such that the electrical resistivity is reduced in response to the z-component of the applied pressure.

The present invention provides a device comprising: a transparent pressure sensing film of the present invention; and a controller coupled to the transparent pressure sensing film for sensing a change in resistance when pressure is applied to the transparent pressure sensing film.

The present invention provides a device comprising: a transparent pressure sensing film of the present invention; a controller coupled to the transparent pressure sensing film for sensing a change in resistance when pressure is applied to the transparent pressure sensing film; and, an electronic display, wherein the transparent pressure sensing film is interfaced with the electronic display.

The present invention provides a method of providing a transparent pressure sensing film, comprising: providing a matrix polymer, wherein the matrix polymer is elastically deformable from a quiescent state; providing a plurality of conductive particles having an average aspect ratio, AR_{avg}, of ≦2; wherein the matrix polymer provided comprises 25 to 100 wt % of an alkyl cellulose; wherein the plurality of conductive particles provided are selected from the group consisting of electrically conductive materials and electrically semiconductive materials; wherein the plurality of conductive particles provided are disposed in the matrix polymer; providing a solvent selected from the group consisting of terpineol, dipropylene glycol methyl ether acetate, dipropylene glycol monomethyl ether, propylene glycol n-propyl ether, dipropylene glycol n-propyl ether, cyclohexanone, butyl carbitol, propylene glycol monomethyl ether acetate, xylene and mixtures thereof; dispersing the matrix polymer and the plurality of conductive particles in the solvent to form a film forming composition; depositing the film forming composition on a substrate; and, curing the film forming composition to provide the transparent pressure sensing film on the substrate.

### BRIEF DESCRIPTION OF THE DRAWINGS

FIG. 1 is a depiction of a perspective top/side view of a transparent pressure sensing film.

FIG. 2 is a representative pressure load-release cycle for a transparent pressure sensitive film containing a plurality of organic-inorganic composite particles.

FIG. 3 is a representative pressure load-release cycle for a transparent pressure sensitive film containing a plurality of organic-inorganic composite particles.

FIG. 4 is a representative pressure load-release cycle for a transparent pressure sensitive film containing a plurality of organic-inorganic composite particles.

### DETAILED DESCRIPTION

Touch sensitive optical displays that enable a pressure input element (i.e., a z-component) along with to the traditional location input (i.e., x,y-component) provide device manufactures with additional flexibility in device design and interface. The transparent pressure sensing films of the present invention provide a key component for such touch sensitive optical displays and offer quick (i.e., cure times of ≦10 minutes) low temperature processability (i.e., curing temperatures of ≦130° C.). The transparent pressure sensing films of the present invention also have good adhesion (preferably ≧4 B) to indium tin oxide coated substrates (e.g., ITO on glass; ITO on PET) while maintaining high transmission (i.e., ≧85%) and low haze (i.e., ≦5%).

The term “electrically non-conductive” as used herein and in the appended claims in reference to the matrix polymer means that the matrix polymer has a volume resistivity, pᵥ, of ≧10⁸Ω·cm as measured according to ASTM D257-14.

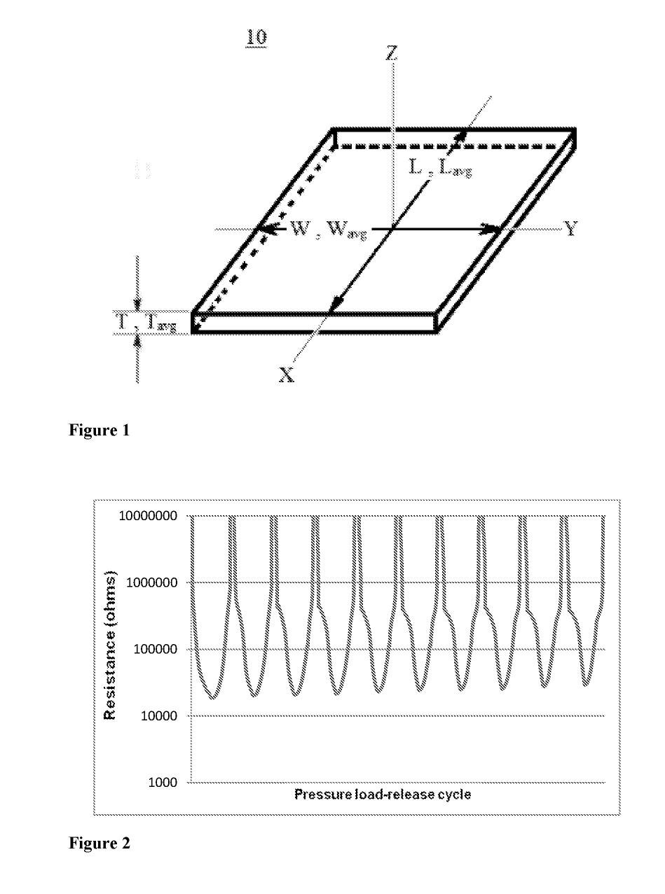

The transparent pressure sensing film (10) of the present invention, comprises: a matrix polymer; and, a plurality of conductive particles having an average aspect ratio, AR_{avg}, of ≦2 (preferably, ≦1.5; more preferably, ≦1.25; most preferably, ≦1.1); wherein the matrix polymer comprises 25 to 100 wt % of an alkyl cellulose; wherein the plurality of conductive particles are selected from the group consisting of electrically conductive materials and electrically semiconductive materials; wherein the plurality of conductive particles are disposed in the matrix polymer; wherein the transparent pressure sensing film contains <10 wt % of the plurality of conductive particles; wherein the transparent pressure sensing film has a length, a width, a thickness, T, and an average thickness, T_{avg}; wherein the average thickness, T_{avg}, is 0.2 to 1,000 μm; wherein the matrix polymer is electrically non-conductive; wherein an electrical resistivity of the transparent pressure sensing film is variable in response to an applied pressure having a z-component directed along the thickness, T, of the transparent pressure sensing film such that the electrical resistivity is reduced in response to the z-component of the applied pressure. (See FIG. 1).

The transparent pressure sensing film (10) of the present invention has a length, L, a width, W, a thickness, T, and an average thickness, T_{avg}. (See FIG. 1.) The length, L, and width, W, of the transparent pressure sensing film (10) are preferably much larger than the thickness, T, of the transparent pressure sensing film (10). The length, L, and width, W, of the transparent pressure sensing film (10) can be selected based on the size of the touch sensitive optical display device in which the transparent pressure sensing film (10) is incorporated. Alternatively, the length, L, and width, W, of the transparent pressure sensing film (10) can be selected based on the method of manufacture. For example, the transparent pressure sensing film (10) of the present invention can be manufactured in a roll-to-roll type operation; wherein the transparent pressure sensing film (10) is later cut to the desired size.

Preferably, the transparent pressure sensing film (10) of the present invention has an average thickness, T_{avg}, of 0.2 to 1,000 μm. More preferably, the transparent pressure sensing film (10) of the present invention has an average thickness, T_{avg}, of 0.5 to 100 μm. Still more preferably, the transparent pressure sensing film (10) of the present invention has an average thickness, T_{avg}, of 1 to 25 μm. Most preferably, the transparent pressure sensing film (10) of the present invention has an average thickness, T_{avg}, of 1 to 5 μm.

Preferably, the transparent pressure sensing film (10) of the present invention reversibly transitions from a high resistance quiescent state to a lower resistance stressed state upon application of a force with a component in the z-direction along the thickness of the film. Preferably, the transparent pressure sensing film (10) transitions from the high resistance quiescent state to the lower resistance stressed state upon application of a pressure with a component in the z-direction with a magnitude of 0.1 to 42 N/cm² (more preferably, of 0.14 to 28 N/cm²). Preferably, the transparent pressure sensing film (10) is capable of undergoing at least 500,000 cycles from the high resistance quiescent state to the lower resistance stressed state while maintaining a consistent response transition. Preferably, the transparent pressure sensing film (10) has a volume resistivity of ≧10⁵Ω·cm when in the quiescent state. More preferably, the transparent pressure sensing film (10) has a volume resistivity of ≧10⁷Ω·cm when in the quiescent state. Most preferably, the transparent pressure sensing film (10) has a volume resistivity of ≧10⁸Ω·cm when in the quiescent state. Preferably, the transparent pressure sensing film (10) has a volume resistivity of <10⁵Ω·cm when subjected to a pressure with a component in the z-direction of 28 N/cm². More preferably, the transparent pressure sensing film (10) has a volume resistivity of <10⁴Ω·cm when subjected to a pressure with a component in the z-direction of 28 N/cm². Most preferably, the transparent pressure sensing film (10) has a volume resistivity of <10³Ω·cm when subjected to a pressure with a component in the z-direction of 28 N/cm².

Preferably, the transparent pressure sensing film (10) of the present invention has a haze, H_{Haze}, of <5% measured according to ASTM D1003-11e1. More preferably, the transparent pressure sensing film (10) of the present invention has a haze, H_{Haze}, of <4% measured according to ASTM D1003-11e1. Most preferably, the transparent pressure sensing film (10) of the present invention has a haze, H_{Haze}, of <3% measured according to ASTM D1003-11e1.

Preferably, the transparent pressure sensing film (10) of the present invention has a transmission, T_{Trans}, of >75% measured according to ASTM D1003-11e1. More preferably, the transparent pressure sensing film (10) of the present invention has a transmission, T_{Trans}, of >85% measured according to ASTM D1003-11e1. Most preferably, the transparent pressure sensing film (10) of the present invention has a transmission, T_{Trans}, of >89% measured according to ASTM D1003-11e1.

Preferably, the matrix polymer comprises 25 to 100 wt % alkyl cellulose. Preferably, the matrix polymer comprises a combination of an alkyl cellulose and a polysiloxane. More preferably, the matrix polymer is a combination of 25 to 75 wt % of an alkyl cellulose and 75 to 25 wt % of a polysiloxane. Still more preferably, the matrix polymer is a combination of 30 to 65 wt % of an alkyl cellulose and 70 to 35 wt % of a polysiloxane. Most preferably, the matrix polymer is a combination of 40 to 60 wt % of an alkyl cellulose and 60 to 40 wt % of a polysiloxane.

Preferably, the alkyl cellulose is a C₁₋₆ alkyl cellulose. More preferably, the alkyl cellulose is a C₁₋₄ alkyl cellulose. Still preferably, the alkyl cellulose is a C₁₋₃ alkyl cellulose. Most preferably, the alkyl cellulose is an ethyl cellulose.

Preferably, the polysiloxane is a hydroxy functional silicone resin. Preferably, the polysiloxane is a hydroxy functional silicone resin having a number average molecular weight of 500 to 10,000 (preferably, 600 to 5,000; more preferably, 1,000 to 2,000; most preferably, 1,500 to 1,750). Preferably, the hydroxy functional silicone resin has an average of 1 to 15 wt % (preferably, 3 to 10 wt %; more preferably, 5 to 7 wt %; most preferably, 6 wt %) hydroxyl groups per molecule. Preferably, the hydroxy functional silicone resin is an alkylphenylpolysiloxane. Preferably, the alkylphenylpolysiloxane has a phenyl to alkyl molar ratio of 5:1 to 1:5 (preferably, 5:1 to 1:1; more preferably, 3:1 to 2:1; most preferably, 2.71:1). Preferably, the alkylphenylpolysiloxane contains alkyl radicals having an average of 1 to 6 carbon atoms per alkyl radical. More preferably, the alkylphenylpolysiloxane contains alkyl radicals having an average of 2 to 4 carbon atoms per alkyl radical. More preferably, the alkylphenylpolysiloxane contains alkyl radicals having an average of 3 carbon atoms per alkyl radical. Preferably, the alkylphenylpolysiloxane has a number average molecular weight of the 500 to 10,000 (preferably, 600 to 5,000; more preferably, 1,000 to 2,000; most preferably, 1,500 to 1,750).

Preferably, the plurality of conductive particles is selected from the group consisting of electrically conductive materials and electrically semiconductive materials. Preferably, the plurality of conductive particles is selected from the group consisting of particles of electrically conductive metals, particles of electrically conductive metal alloys, particles of electrically conductive metal oxides, particles of electrically conductive oxides of metal alloys; and, mixtures thereof. More preferably, the plurality of conductive particles is selected from the group consisting of antimony doped tin oxide (ATO) particles; silver particles; and, mixtures thereof. Most preferably, the plurality of conductive particles is selected from the group consisting of antimony doped tin oxide (ATO) and silver particles.

Preferably, the transparent pressure sensing film (10) of the present invention contains <10 wt % of the plurality of conductive particles. More preferably, the transparent pressure sensing film (10) of the present invention contains 0.01 to 9.5 wt % of the plurality of conductive particles. Still more preferably, the transparent pressure sensing film (10) of the present invention contains 0.05 to 5 wt % of the plurality of conductive particles. Most preferably, the transparent pressure sensing film (10) of the present invention contains 0.5 to 3 wt % of the plurality of conductive particles.

Preferably, the plurality of conductive particles is a plurality of composite particles; wherein each composite particle comprises a plurality of primary particles bonded together with an organic binder. Preferably, the plurality of composite particles are spray dried particles.

Preferably, the plurality of primary particles has an average particle size of 10 to 100 nm and is selected from the group consisting of electrically conductive materials; electrically semiconductive materials; and, mixtures thereof. Preferably, the plurality of primary particles is selected from the group consisting of particles of electrically conductive metals, particles of electrically conductive metal alloys, particles of electrically conductive metal oxides, particles of electrically conductive oxides of metal alloys; and, mixtures thereof. More preferably, the plurality of primary particles is selected from the group consisting of antimony doped tin oxide (ATO) particles; silver particles; and, mixtures thereof. Most preferably, the plurality of primary particles is selected from the group consisting of antimony doped tin oxide (ATO) and silver particles.

Preferably, the organic binder is selected from the group consisting of vinyl acetate polymers, acrylic polymers, polyurethane polymers, epoxy polymers, polyolefin polymers, alkyl celluloses, silicone polymers and combinations thereof. More preferably, the organic binder is an acrylic polymer. Most preferably, the organic binder is a hollow core acrylic polymer.

Preferably, the plurality of composite particles are reversibly convertible between a high resistance state when quiescent and a low resistance, non-quiescent state when subjected to a compressive force.

Preferably, the transparent pressure sensing film (10) of the present invention contains <10 wt % of the plurality of composite particles. More preferably, the transparent pressure sensing film (10) of the present invention contains 0.01 to 9.5 wt % of the plurality of composite particles. Still more preferably, the transparent pressure sensing film (10) of the present invention contains 0.05 to 5 wt % of the plurality of composite particles. Most preferably, the transparent pressure sensing film (10) of the present invention contains 0.5 to 3 wt % of the plurality of composite particles.

Preferably, the plurality of conductive particles has an average particle size, PS_{avg}, of 10 nm to 50 μm. More preferably, the plurality of conductive particles is a plurality of composite particles having an average particles size, PS_{avg}, of 1 to 30 μm. Most preferably, the plurality of conductive particles is a plurality of composite particles having an average particle size, PS_{avg}, of 1 to 20 μm.

Preferably, the transparent pressure sensing film (10) of the present invention reversibly transitions from a high resistance quiescent state to a lower resistance non-quiescent state upon application of a force with a component in the z-direction along the thickness of the film. Preferably, the transparent pressure sensing film (10) reversibly transitions from the high resistance quiescent state to the lower resistance non-quiescent state upon application of a pressure with a component in the z-direction with a magnitude of 0.1 to 42 N/cm² (more preferably, of 0.14 to 28 N/cm²). Preferably, the transparent pressure sensing film (10) is capable of undergoing at least 100,000 cycles from the high resistance quiescent state to the lower resistance non-quiescent state while maintaining a consistent response transition. Preferably, the transparent pressure sensing film (10) has a volume resistivity of ≧10⁵Ω·cm when in the quiescent state. More preferably, the transparent pressure sensing film (10) has a volume resistivity of ≧10⁷Ω·cm when in the quiescent state. Most preferably, the transparent pressure sensing film (10) has a volume resistivity of ≧10⁸Ω·cm when in the quiescent state. Preferably, the transparent pressure sensing film (10) has a volume resistivity of <10⁵Ω·cm when subjected to a pressure with a component in the z-direction of 28 N/cm². More preferably, the transparent pressure sensing film (10) has a volume resistivity of <10⁴Ω·cm when subjected to a pressure with a component in the z-direction of 28 N/cm². Most preferably, the transparent pressure sensing film (10) has a volume resistivity of <10³Ω·cm when subjected to a pressure with a component in the z-direction of 28 N/cm².

Preferably, the matrix polymer used in the transparent pressure sensing film (10) of the present invention has a volume resistivity, pᵥ, of ≧10⁸Ω·cm measured according to ASTM D257-14. More preferably, the matrix polymer used in the transparent pressure sensing film (10) of the present invention has a volume resistivity, pᵥ, of ≧10¹⁰Ω·cm measured according to ASTM D257-14. Most preferably, the matrix polymer used in the transparent pressure sensing film (10) of the present invention has a volume resistivity, pᵥ, of 10¹² to 10¹⁸Ω·cm measured according to ASTM D257-14.

Preferably, the matrix polymer used in the transparent pressure sensing film (10) of the present invention is elastically deformable from a quiescent state to a non-quiescent state when compressed through the application of a pressure with a component in the z-direction. More preferably, the matrix polymer used in the transparent pressure sensing film (10) of the present invention is elastically deformable from a quiescent state to a non-quiescent state when compressed through the application of a pressure with a component in the z-direction of 0.1 to 42 N/cm². Most preferably, the matrix polymer used in the transparent pressure sensing film (10) of the present invention is elastically deformable from a quiescent state to a non-quiescent state when compressed through the application of a pressure with a component in the z-direction of 0.14 to 28 N/cm².

Preferably, the plurality of conductive particles are disposed in the matrix polymer. More preferably, the plurality of conductive particles are at least one of dispersed and arranged throughout the matrix polymer. Most preferably, the plurality of conductive particles are dispersed throughout the matrix polymer.

The method of providing a transparent pressure sensing film of the present invention, comprises: providing a matrix polymer, wherein the matrix polymer is elastically deformable from a quiescent state; providing a plurality of conductive particles having an average aspect ratio, AR_{avg}, of ≦2 (preferably, ≦1.5; more preferably, ≦1.25; most preferably, ≦1.1); wherein the matrix polymer provided comprises 25 to 100 wt % of an alkyl cellulose; wherein the plurality of conductive particles provided are selected from the group consisting of electrically conductive materials and electrically semiconductive materials; wherein the plurality of conductive particles provided are disposed in the matrix polymer; providing a solvent selected from the group consisting of terpineol, dipropylene glycol methyl ether acetate, dipropylene glycol monomethyl ether, propylene glycol n-propyl ether, dipropylene glycol n-propyl ether, cyclohexanone, butyl carbitol, propylene glycol monomethyl ether acetate, xylene and mixtures thereof dispersing the matrix polymer and the plurality of conductive particles in the solvent to form a film forming composition; depositing the film forming composition on a substrate; and, curing the film forming composition to provide the transparent pressure sensing film on the substrate.

Preferably, in the method of providing a transparent pressure sensing film of the present invention, the matrix polymer is included in the film forming composition at a concentration of 0.1 to 50 wt %. More preferably, the matrix polymer is included in the film forming composition at a concentration of 1 to 30 wt %. Most preferably, the matrix polymer is included in the film forming composition at a concentration of 5 to 20 wt %.

Preferably, in the method of providing a transparent pressure sensing film of the present invention, the film forming composition is deposited on the substrate using well known deposition techniques. More preferably, the film forming composition is applied to a surface of the substrate using a process selected from the group consisting of spray painting, dip coating, spin coating, knife coating, kiss coating, gravure coating, screen printing, ink jet printing and pad printing. More preferably, the film forming composition is applied to a surface of the substrate using a process selected from the group consisting of dip coating, spin coating, knife coating, kiss coating, gravure coating and screen printing. Most preferably, the combination is applied to a surface of the substrate by a process selected from knife coating and screen printing.

Preferably, in the method of providing a transparent pressure sensing film of the present invention, the film forming composition is cured to provide the transparent pressure sensing film on the substrate. Preferably, volatile components in the film forming composition such as the solvent are removed during the curing process. Preferably, the film forming composition is cured by heating. Preferably, the film forming composition is heated by a process selected from the group consisting of burn-off, micro pulse photonic heating, continuous photonic heating, microwave heating, oven heating, vacuum furnace heating and combinations thereof. More preferably, the film forming composition is heated by a process selected from the group consisting of oven heating and vacuum furnace heating. Most preferably, the film forming composition is heated by oven heating.

Preferably, the film forming composition is cured by heating at a temperature of 100 to 200° C. More preferably, the film forming composition is cured by heating at a temperature of 120 to 150° C. Still more preferably, the film forming composition is cured by heating at a temperature of 125 to 140° C. Most preferably, the film forming composition is cured by heating at a temperature of 125 to 135° C.

Preferably, the film forming composition is cured by heating at a temperature of 100 to 200° C. for a period of 1 to 45 minutes. More preferably, the film forming composition is cured by heating at a temperature of 120 to 150° C. for a period of 1 to 45 minutes (preferably, 1 to 30 minutes; more preferably, 5 to 15 minutes; most preferably, for 10 minutes). Still more preferably, the film forming composition is cured by heating at a temperature of 125 to 140° C. for a period of 1 to 45 minutes (preferably, 1 to 30 minutes; more preferably, 5 to 15 minutes; most preferably, for 10 minutes). Most preferably, the film forming composition is cured by heating at a temperature of 125 to 135° C. for a period of 1 to 45 minutes (preferably, 1 to 30 minutes; more preferably, 5 to 15 minutes; most preferably, for 10 minutes).

Preferably, in the method of providing a transparent pressure sensing film of the present invention, the transparent pressure sensing film provided on the substrate has an average thickness, T_{avg}, of 0.2 to 1,000 μm. More preferably, the transparent pressure sensing film provided on the substrate has an average thickness, T_{avg}, of 0.5 to 100 μm. Still more preferably, the transparent pressure sensing film provided on the substrate has an average thickness, T_{avg}, of 1 to 25 μm. Most preferably, the transparent pressure sensing film provided on the substrate has an average thickness, T_{avg}, of 1 to 5 μm.

Preferably, in the method of providing a transparent pressure sensing film of the present invention, the plurality of conductive particles provided is a plurality of composite particles selected to have an average particle size, PS_{avg}, such that 0.5*T_{avg}≦PS_{avg}≦1.5*T_{avg} in the transparent pressure sensing film provided on the substrate. More preferably, in the method of providing a transparent pressure sensing film of the present invention, the plurality of conductive particles provided is a plurality of composite particles selected to have an average particle size, PS_{avg}, such that 0.75*T_{avg}≦PS_{avg}≦1.25*T_{avg} in the transparent pressure sensing film provided on the substrate. Most preferably, in the method of providing a transparent pressure sensing film of the present invention, the plurality of conductive particles provided is a plurality of composite particles selected to have an average particle size, PS_{avg}, such that T_{avg}<PS_{avg}≦1.1*T_{avg} in the transparent pressure sensing film provided on the substrate.

The device of the present invention, comprises: a transparent pressure sensing film of the present invention; and, a controller coupled to the transparent pressure sensing film for sensing a change in resistance when pressure is applied to the transparent pressure sensing film.

Preferably, the device of the present invention, further comprises an electronic display, wherein the transparent pressure sensing film is interfaced with the electronic display. More preferably, the transparent pressure sensing film overlays the electronic display.

Some embodiments of the present invention will now be described in detail in the following Examples.

The transmission, T_{Trans}, data reported in the Examples were measured according to ASTM D1003-11e1 using a BYK Gardner Spectrophotometer. Each pressure sensing film sample on ITO glass was measured at three different points, with the average of the measurements reported.

The haze, H_{Haze}, data reported in the Examples were measured according to ASTM D1003-11e1 using a BYK Gardner Spectrophotometer. Each pressure sensing film sample on ITO glass was measured at three different points, with the average of the measurements reported.

### EXAMPLE 1

### Composite Conductive Particles

Composite conductive particles were prepared by spray drying an aqueous dispersion using a B-290 spray dryer from BÜCHI Labortechnik AG with a 1.5 mm nozzle. The aqueous dispersion sprayed through the spray dryer contained a first hollow core acrylic resin with an average 1.2 μm diameter (5 g; HP1055 Ropaque™ polymer available from The Dow Chemical Company); a second hollow core acrylic resin with an average 120 nm diameter (1 g; MSRC2731 Ropaque™ polymer available from The Dow Chemical Company); a waterborne antimony doped tin oxide (ATO) (10 g, on a solids basis, WP-020 from Shanghai Huzheng Nanotechnology Co., Ltd.); and, defoamer (3 mg, Foamaster® NXZ defoamer from Air Products and Chemicals, Inc.) dispersed in deionized water (200 g) in air at 100° C. and a fluid flow rate of 10 mL/min. The product spray dried composite conductive particles formed had a particle size distribution of 1 to 20 μm; with an average particle size of 10 μm.

### EXAMPLES 2-10

### Matrix Polymer Preparation

The matrix polymers of Examples 2-10 were prepared by dissolving ethylcellulose (as noted in TABLE 1) into a in a 7:3 weight ratio solvent mixture of terpineol and glycol methyl ether acetate (Dowanol™ DMPA from The Dow Chemical Company); followed by the addition of polysiloxane (as noted in TABLE 1) to provide a polymer solution having a solids content of 10 wt % and an ethylcellulose to polysiloxane weight ratio as noted in TABLE 1.

TABLE 1

| | Ethylcellulose | Ethylcellulose | |
|---|---|---|---|
| | EC100 ^{Φ} | EC10 ^{λ} | Polysiloxane [symbol] |
| Ex. | (wt %) | (wt %) | (wt %) |
| 2 | 100 | — | — |
| 3 | — | 100 | — |
| 4 | 40 | — | 60 |
| 5 | 50 | — | 50 |
| 6 | 60 | — | 40 |
| 7 | 70 | — | 30 |
| 8 | — | 60 | 40 |
| 9 | — | 65 | 35 |
| 10 | — | 70 | 30 |

### EXAMPLES 11-22

### Matrix Polymer Film Preparation

Matrix polymer films of Examples 11-22 were provided by depositing the matrix polymers as noted in TABLE 2 on the substrate as noted in TABLE 2. In each of Examples 11-22 a mechanical drawdown process with a 50 μm blade was used to form the film. The films were then cured at the temperature noted in TABLE 2 for 10 minutes.

TABLE 2

| Ex. # | Matrix polymer from Ex # | Substrate | Cure Temp (° C.) |
|---|---|---|---|
| 11 | Ex. 2 | A | 120 |
| 12 | Ex. 3 | A | 160 |
| 13 | Ex. 3 | B | 130 |
| 14 | Ex. 7 | A | 140 |
| 15 | Ex. 7 | A | 160 |
| 16 | Ex. 6 | A | 130 |
| 17 | Ex. 5 | A | 130 |
| 18 | Ex. 10 | A | 130 |
| 19 | Ex. 4 | B | 130 |
| 20 | Ex. 8 | B | 130 |
| 21 | Ex. 4 | C | 130 |
| 22 | Ex. 9 | C | 130 |

A—Indium tin oxide coated glass slide having a resistance of 15Ω available from Wesley Glass Technology, Ltd. (“ITO glass”)
B—Indium tin oxide coated polyethylene terephthalate available from SKC-Haas Display Films Co., Ltd. (“ITO PET”)
C—Substrate of B corona treated at 150 V. (“ITO PET-corona”)

### Matrix Polymer Film Adhesion

The matrix polymer films deposited on substrates as noted Examples 11-22 were evaluated to assess their adhesion to the substrate according to ASTM D3359-09 and using Scotch® 8915 tape available from 3M. The results are listed in TABLE 3.

TABLE 3

| Matrix polymer film | |
|---|---|
| deposited according Ex # | Adhesion |
| Ex. 11 | 0 B |
| Ex. 12 | 4 B |
| Ex. 13 | 0 B |
| Ex. 14 | 2 B |
| Ex. 15 | 5 B |
| Ex. 16 | 2 B |
| Ex. 17 | 5 B |
| Ex. 18 | 5 B |
| Ex. 19 | 3 B |
| Ex. 20 | 5 B |
| Ex. 21 | 5 B |
| Ex. 22 | 5 B |

### Matrix Polymer Film Transparency and Haze

The transmission, T_{Trans}, and haze, H_{Haze}, of the matrix polymer films deposited on substrates prepared according to each of Examples 11-22 are provided in TABLE 4.

TABLE 4

| Bare substrate or | | |
|---|---|---|
| Film on Substrate, Ex # | T_{Tans} (in %) | H_{Haze} (in %) |
| A | 86.7 | 0.08 |
| B | 89.6 | 0.10 |
| C | 89.8 | 0.14 |
| Ex. 11 | 89.7 | 0.08 |
| Ex. 12 | 89.7 | 0.20 |
| Ex. 13 | 91.5 | 0.24 |
| Ex. 14 | 89.5 | 0.07 |
| Ex. 15 | 89.7 | 0.05 |
| Ex. 16 | 89.5 | 0.06 |
| Ex. 17 | 89.6 | 0.09 |
| Ex. 18 | 89.7 | 0.09 |
| Ex. 19 | 91.2 | 0.12 |
| Ex. 20 | 91.5 | 0.15 |
| Ex. 21 | 91.2 | 0.14 |
| Ex. 22 | 91.5 | 0.19 |

A—ITO glass
B—ITO PET
C—ITO PET-corona

### EXAMPLES 23-25

### Pressure Sensing Ink Formulations

The pressure sensing ink formulations in Examples 23-25 were prepared by dispersing composite particles prepared according to Example 1 into the matrix polymers prepared according to Examples 2 and 4-5, respectively, to provide a composite particle concentration of 1 wt % in each of the pressure sensing ink formulations.

### EXAMPLES 26-28

### Pressure Sensing Films

Pressure sensing films in Examples 26-28 were provided by depositing pressure sensing ink formulations prepared according to Example 23-25 as noted in TABLE 5 on the substrate as noted in TABLE 5. In each of Examples 26-28 a mechanical drawdown process with the blade gap of 25 μm was used to form the film. The films were then cured at 130° C. for 10 minutes.

The transmission, T_{Trans}, and haze, H_{Haze}, of the pressure sensing films of Examples 26-28 are provided in TABLE 5.

TABLE 5

| | Pressure | | | |
|---|---|---|---|---|
| Ex. | sensing ink, Ex # | Substrate | T_{Tans} (in %) | H_{Haze} (in %) |
| 38 | Ex. 2 | A | 89.4 | 1.54 |
| 39 | Ex. 5 | A | 89.1 | 2.11 |
| 40 | Ex. 4 | C | 90.7 | 2.91 |

A—ITO glass
C—ITO PET-corona

### EXAMPLES 29-31

### Pressure Sensing Response

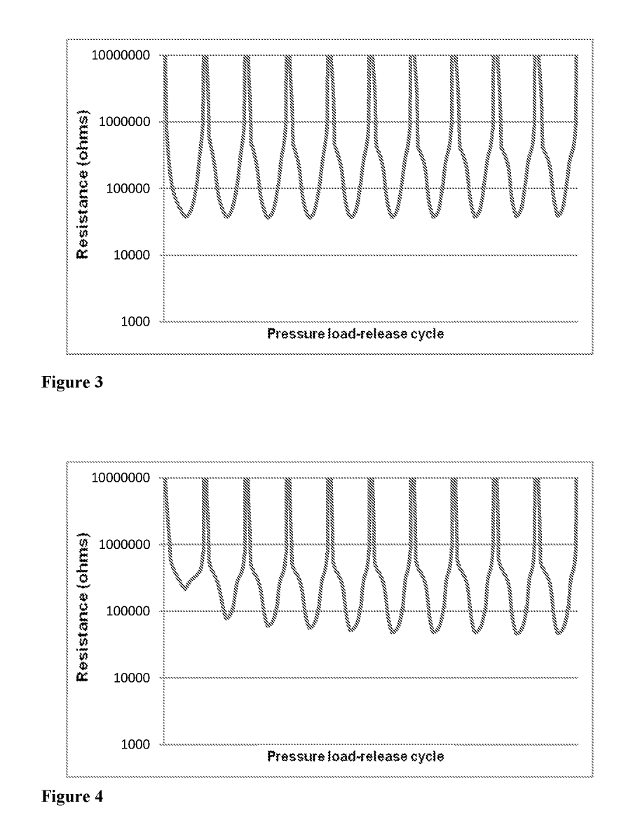

An indium-tin oxide coated polyethylene terephthalate film was placed over the pressure sensing films prepared according to each of Examples 26-28 with the indium-tin oxide (ITO) coated surface facing the pressure sensing film. The resistance response of each of the pressure sensing films was then evaluated at three different points using a robot arm integrated with a spring to control the input pressure on a steel disk probe (1 cm diameter) placed on the untreated surface of the polyethylene terephthalate film. The input pressure exerted on the film stack through the steel disk probe was varied between 1 and 200 g. The resistance exhibited by the pressure sensing films was recorded using a resistance meter having one probe connected to the indium tin oxide coated substrate slide and the one probe connected to the over laid indium-tin oxide coated polyethylene terephthalate film. A graph of the pressure versus resistance for the pressure sensing film prepared according to each of Examples 29-31 are provided in FIGS. 2-4, respectively.

We claim:

1. A transparent pressure sensing film, comprising:
a matrix polymer; and,
a plurality of conductive particles; having an average aspect ratio, AR_{avg}, of ≦2;
wherein the matrix polymer comprises 25 to 100 wt % of an alkyl cellulose;
wherein the plurality of conductive particles are selected from the group consisting of electrically conductive materials and electrically semiconductive materials;
wherein the plurality of conductive particles are disposed in the matrix polymer;
wherein the transparent pressure sensing film contains <10 wt % of the plurality of conductive particles;
wherein the transparent pressure sensing film has a length, a width, a thickness, T, and an average thickness, T_{avg};
wherein the average thickness, T_{avg}, is 0.2 to 1,000 μm;
wherein the matrix polymer is electrically non-conductive;
wherein an electrical resistivity of the transparent pressure sensing film is variable in response to an applied pressure having a z-component directed along the thickness, T, of the transparent pressure sensing film such that the electrical resistivity is reduced in response to the z-component of the applied pressure.

2. The transparent pressure sensing film of claim 1, wherein the matrix polymer further comprises a polysiloxane.

3. The transparent pressure sensing film of claim 2, wherein the matrix polymer is a combination of 25 to 75 wt % of the alkyl cellulose and 75 to 25 wt % of the polysiloxane.

4. The transparent pressure sensing film of claim 1, wherein the plurality of conductive particles are selected from the group consisting of antimony doped tin oxide (ATO) particles and silver particles.

5. The transparent pressure sensing film of claim 1,
wherein the plurality of conductive particles is a plurality of composite particles;
wherein each composite particles comprises a plurality of primary particles bonded together with an organic binder; and,
wherein the plurality of primary particles are selected from the group consisting of electrically conductive materials and electrically semiconductive materials.

6. The transparent pressure sensing film of claim 5, wherein the plurality of composite particles has aparticle size, PS_{avg}, of 1 to 50 μm.

7. A device comprising:
a transparent pressure sensing film according to claim 1; and
a controller coupled to the transparent pressure sensing film for sensing a change in resistance when pressure is applied to the transparent pressure sensing film.

8. The device of claim 7, further comprising:
an electronic display,
wherein the transparent pressure sensing film is interfaced with the electronic display.

9. The device of claim 8, wherein the transparent pressure sensing film overlays the electronic display.

10. A method of providing a transparent pressure sensing film, comprising:
providing a matrix polymer, wherein the matrix polymer is elastically deformable from a quiescent state;
providing a plurality of conductive particles having an average aspect ratio, AR_{avg}, of ≦2;
wherein the matrix polymer provided comprises 25 to 100 wt % of an alkyl cellulose;
wherein the plurality of conductive particles provided are selected from the group consisting of electrically conductive materials and electrically semiconductive materials;
wherein the plurality of conductive particles provided are disposed in the matrix polymer;
providing a solvent selected from the group consisting of terpineol, dipropylene glycol methyl ether acetate, dipropylene glycol monomethyl ether, propylene glycol n-propyl ether, dipropylene glycol n-propyl ether, cyclohexanone, butyl carbitol, propylene glycol monomethyl ether acetate, xylene and mixtures thereof;
dispersing the matrix polymer and the plurality of conductive particles in the solvent to form a film forming composition;
depositing the film forming composition on a substrate; and,
curing the film forming composition to provide the transparent pressure sensing film on the substrate.
